(19) United States
(12) Patent Application Publication
(10) Pub. No.: US 2004/0006742 A1
(43) Pub. Date: Jan. 8, 2004

(54) Document structure identifier

(76) Inventor: David N. Slocombe, Toronto (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/441,071

(22) Filed: May 20, 2003

Related U.S. Application Data
(60) Provisional application No. 60/381,365, filed on May 20, 2002.

(51) Int. Cl. G06F 15/00

(52) U.S. Cl. 715/513

(57) ABSTRACT

A method of automated document structure identification based on visual cues is disclosed herein. The two dimensional layout of the document is analyzed to discern visual cues related to the structure of the document, and the text of the document is tokenized so that similarly structured elements are treated similarly. The method can be applied in the generation of extensible mark-up language files, natural language parsing and search engine ranking mechanisms.

### CROSS REFERENCE TO RELATED APPLICATIONS

This application claims the benefit of priority from U.S. Provisional Application No. 60/381,365 filed on May 20, 2002.

### FIELD OF THE INVENTION

The present invention relates generally to identifying the structure in a document. More particularly, the present invention relates to a method of automated structure identification in electronic documents.

### BACKGROUND OF THE INVENTION

Extensible Mark-up Language (XML) provides a convenient format for maintaining electronic documents for access across a plurality of channels. As a result of its broad applicability in a number of fields there has been great interest in XML authoring tools.

The usefulness of having documents in a structured, parsable, reusable format such as XML is well appreciated. There is, however, no reliable method for the creation of consistent documents other than manual creation of the document by entry of the tags required to properly mark up the text. This approach to human-computer interaction is backwards: just as people are not expected to read XML-tagged documents directly, they should not be expected to write them either.

An alternative to the manual creation of XML documents is provided by a variety of applications that can either export a formatted document to an XML file or natively store documents in an XML format. These XML document creation applications are typically derived using algorithms similar to HTML creation plugins for word processors. Thus they suffer from many of the same drawbacks, including the ability to provide XML tags for text explicitly described as belonging to a particular style. As an example, a line near the top of a page of laid out text may be centered across a number of columns, and formatted in a large and bold typeface. Instinctively, a reader will deduce that this is a title, but the XML generators known to date, will only identify it as a title or heading if the user has applied a “title style” designation. Thus ensuring proper XML markup replies upon the user either directly or indirectly providing the XML markup codes. One skilled in the art will appreciate that this is difficult to guarantee, as it requires most users to change the manner in which they presently use word processing or layout tools.

Additionally, conventional XML generation tools are linear in their structure and do not recognize overall patterns in documents. For example, a sequential list, if not identified as such, is typically rendered as a purely linear stream of text. In another example, the variety of ways that a bulleted list is created can cause problems for the generator. To create the bullet the user can either set a tab stop or use multiple space characters to offset the bullet. The bullet could then be created by inserting a bullet character from the specified typeface. Alternatively, a period can be used as a bullet by increasing its font size and making it superscripted. As another alternative the user can select the bullet tool to accomplish the same task. Instead of using either the tab or a grouping of spaces the user can insert a bullet in a movable text frame and position it in the accepted location. Graphical elements could be used instead of textual elements to create the bullet. In all these cases the linear parsing of the data file will result in different XML code being created to represent the different set of typographical codes used. However, to a reader all of the above described constructs are identical, and so intuitively one would expect the similar XML code to be generated.

The problems described here in relation to the linear processing of data streams arise from the inability of one-dimensional parsers to properly derive a context for the text that they are processing. Whereas a human reader can easily distinguish a context for the content, one-dimensional parsers cannot take advantage of visual cues provided by the format of the document. The visual cues used by the human reader to distinguish formatting and implied designations is based upon the two dimensional layout of the material on the page, and upon the consistency between pages.

It is, therefore, desirable to provide an XML generating engine that derives context for the content based on visual cues available from the document.

### SUMMARY OF THE INVENTION

It is an object of the present invention to obviate or mitigate at least one disadvantage of previous document identification systems.

In a first aspect of the present invention there is provided a method of creating a document structure model of a computer parsable document having contents on at least one page. The method comprises the steps of identifying the contents of the document as segments, creating tokens to characterize the content and structure of the document and creating the document structure model. Each of the identified segments has defined characteristics and represents structure in the document. Each token is associated with one of the at least one pages and are based on the position of each segment in relation to other segments on the same page, each token has characteristics defining a structure in the document determined in accordance with the structure of the page associated with the token. The document structure model is created in accordance with the characteristics of the tokens across all of the at least one page of the document.

In presently preferred embodiments of the present invention, the computer parsable document is in a page description language, and the step of identifying the contents of the document includes the step of converting the page description language to a linearized, two dimensional format. A segment type for each segment is selected from a list including text segments, image segments and rule segments to represent character based text, vector and bitmapped images and rules respectively, where text segments represent strings of text having a common baseline. Characteristics of the tokens define a structure selected from a list including candidate paragraphs, table groups, list mark candidates, Dividers, and Zones. One token contains at least one segment, and the characteristics of the one token are determined in accordance with the characteristics of the contained segment. If one token contains at least one other token, the characteristics of the container token are determined in accordance with the characteristics of the contained token. Preferably each token is assigned an identification number which includes a geometric index for tracking the location of tokens in the document. The document structure model is created using rules based processing of the characteristics of the tokens, and at least two disjoint Zones are represented in the document structure model as a Galley. A paragraph candidate is represented in the document structure model as a structure selected from a list including Titles, bulleted lists, enumerated lists, inset blocks, paragraphs, block quotes and tables.

In a second aspect of the present invention, there is provided a system for creating a document structure model using the method of the first aspect of the present invention. The system comprises a visual data acquirer, a visual tokenizer, and a document structure identifier. The visual data acquirer is for identifying the segments in the document. The visual tokenizer creates the tokens characterizing the document, and is connected to the visual data acquirer for receiving the identified segments. The document structure identifier is for creating the document structure model based on the tokens received from the visual tokenizer.

In another aspect of the present invention there is provided a system for translating a computer parsable document into extensible markup language that includes the system of the second aspect and a translation engine for reading the document structure model created by the document structure identifier and creating an Extensible Markup Language file, and Hypertext Markup Language File or a Standard Generalized Markup Language File in accordance with the content and structure of document structure model.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is an example of an offset and italicized block quote;

FIG. 2 is an example of an offset and smaller font block quote;

FIG. 3 is an example of a non-offset but italicized block quote;

FIG. 4 is an example of a non-offset but smaller font block quote;

FIG. 5 is an example of a block quote using quotation marks;

FIG. 6 is a screenshot of the identification of a TSeg during visual data acquisition;

FIG. 7 is a screenshot of the identification of an RSeg during visual data acquisition;

FIG. 8 is a screenshot of the identification of a list mark candidate during visual tokenization;

FIG. 9 is a screenshot of the identification of a RSeg Divider during visual tokenization;

FIG. 10 is a screenshot of the tokenization of a column Zone during visual tokenization;

FIG. 11 is a screenshot of the tokenization of a footnote Zone during visual tokenization;

FIG. 12 is a screenshot of the identification of an enumerated list during the document structure identification;

FIG. 13 is a screenshot of the identification of a list title during the document structure identification;

FIG. 14 is a screenshot of the an enumerated list during the document structure identification;

FIG. 15 is a flowchart illustrating a method of the present invention; and

FIG. 16 is a block diagram of a system of the present invention.

### DETAILED DESCRIPTION

The present invention provides a two dimensional XML generation process that gleans information about the structure of a document from both the typographic characteristics of its content as well as the two dimensional relationship between elements on the page. The present invention uses both information about the role of an element on a page and its role in the overall document to determine the purpose of the text. As will be described below, information about the role of a passage of text can be determined from visual cues in the vast majority of documents, other than those whose typography is designed to be esoteric and cause confusion to both human and machine interpreters.

While prior art XML generators rely upon styles defined in a source application to determine the tags that will be associated with text, the present invention starts by analyzing the two dimensional layout of individual pages in a potentially multipage document. To facilitate the two dimensional analysis, a presently preferred embodiment of the invention begins a visual data acquisition phase on a page description language (PDL) version of the document. One skilled in the art will appreciate that there are a number of PDLs including Adobe PostScrip™ and Portable Document Format (PDF), in addition to Hewlett Packard's Printer Control Language (PCL) and a variety of other printer control languages that are specific to different printer manufacturers. One skilled in the art will also appreciate that a visual data acquisition as described below could be implemented on any machine readable format that provides the two dimensional description of the page, though the specific implementation details will vary.

The motivation for this approach is the contention that virtually all documents already have sufficient visual markers of structure to make them parsable. The clearest indication of this is the commonplace observation that a reader rarely encounters a printed document whose logical structure cannot be mentally parsed at a glance. There are documents that fail this test, and they are generally considered to be ambiguous to both humans and machines. These documents are the result of authors or typographers who did not sufficiently follow commonly understood rules of layout. As negative examples, some design-heavy publications deliberately flout as many of these rules as they can get away with; this is entertaining, but hardly helps a reader to discern document structure.

Two-dimensional identification parses a page into objects, based on formatting, position, and context. It then considers page layout holistically, building on the observation that pages tend to have a structure or geometry that includes one or more of a header, footer, body, and footnotes. A software system can employ pattern and shape recognition algorithms to identify objects and higher-level structures defined by general knowledge of typographic principles.

Two-dimensional parsing also more closely emulates the human eye-brain system for understanding printed documents. This approach to structure identification is based on determining which sets of typographical properties are distinctive of specific objects. Some examples will demonstrate how human beings use typographical cues to distinguish structure.

TABLE 1
four sample lists illustrating implied structure based on layout.

| | | | |
|---|---|---|---|
| 1. ceny | 1. ceny | 1. ceny | |
| a. stawki | 1. stawki | a. stawki | 1. ceny |
| b. bonifikaty | 2. bonifikaty | b. bonifikaty | 1. stawki |
| c. obrocie | 3. obrocie | c. obrocie | 2. bonifikaly |
| d. zasady | 4. zasady | d. zasady | 2. nielegalny |
| 2. nielegalny | 2. nielegalny | 2. nielegalny | |

Table 1 contains four lists that show that despite not understanding the meaning of words a reader can comprehend the structure of a list by visual cues. First is a simple list, with another nested list inside it. It's easy to tell this because there are two significant visual clues that the second through fifth items are members of a sub-list. The first visual clue is that the items are indented to the right-perhaps the most obvious indication. The second visual clue is that they use a different numbering style (alphabetic rather than numeric).

In the second list, the sub-list uses the same numbering style, but it is still indented, so a reader can easily infer the nested structure.

The third list is a bit more unusual, and many people would say it is typeset badly, because all the items are indented the same distance. Nonetheless, a reader can conclude with a high degree of certainty that the second through fifth items are logically nested, since they use a different numbering scheme. Because the sub-list can be identified without it being indented, it can be deduced that numbering scheme has a higher weight than indentation in this context.

The fourth list is not clearly understandable. Not only are all of the items indented identically the list enumeration is repeated and no visual cues are provided to indicate why. A reader would be quite justified in concluding that the structure of this list cannot be deciphered with any confidence. By making certain assumptions, it may be possible to guess at a structure, but it might not be the one that the author intended.

The same observations can be applied to non-numbered lists. Typically non-numbered lists use bullets, which may vary in their style.

TABLE 2
four sample bulleted lists illustrating implied structure based on layout.

| | | | |
|---|---|---|---|
| • ceny | • ceny | • ceny | • ceny |
| ∘ stawki | • stawki | ∘ stawki | • stawki |
| ∘ boniftkaty | • bonifikaty | ∘ bonifikaty | • bonifikaty |
| ∘ obrocie | • obrocie | ∘ obrocie | • obrocie |
| ∘ zasady | • zasady | ∘ zasady | • zasady |
| • melegaIny | • melegalny | • nielegalny | • melegalny |

The first example clearly contains a nested list: the second through fifth items are indented, and have a different bullet character than the first and sixth items. The second example is similar. Even though all items use the same bullet character, the indent implies that some items are nested. In the third example, even without the indentation a reader can easily determine that the middle items are in a sub-list because the unfilled bullet characters are clearly distinct.

The fourth example presents somewhat of a dilemma. None of the items are indented, and while a reader may be able to tell that the second through fifth bullets are different, it is not necessarily sufficient to arrive at the conclusion that they indicate items in a sublist. This is an example where both humans and software programs may rightly conclude that the situation is ambiguous. The above discussion shows that when recognizing a nested bulleted list, indentation has a higher weighting than the choice of list mark.

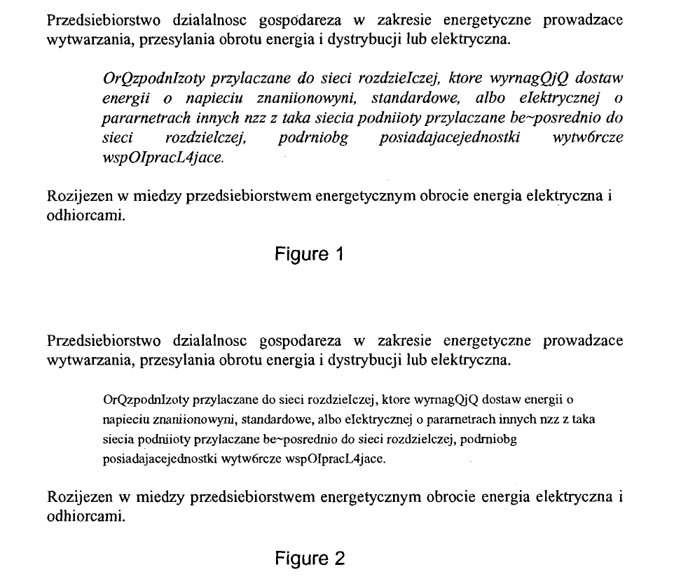

Another common typographical structure is a block quote. This structure is used to offset a quoted section. FIG. 1 illustrates a first example of a block quote. Several different cues are used when recognizing a block quote: font and font style, indentation, inter-line spacing, quote marks, and Dividers. This is a somewhat simplified example since other constructs such as notes and warnings may have formatting attributes similar to those of block quotes. In FIG. 1, the quoted material is indented and italicized. In FIG. 2, the quote is again emphasized in two ways: by indentation and point size.

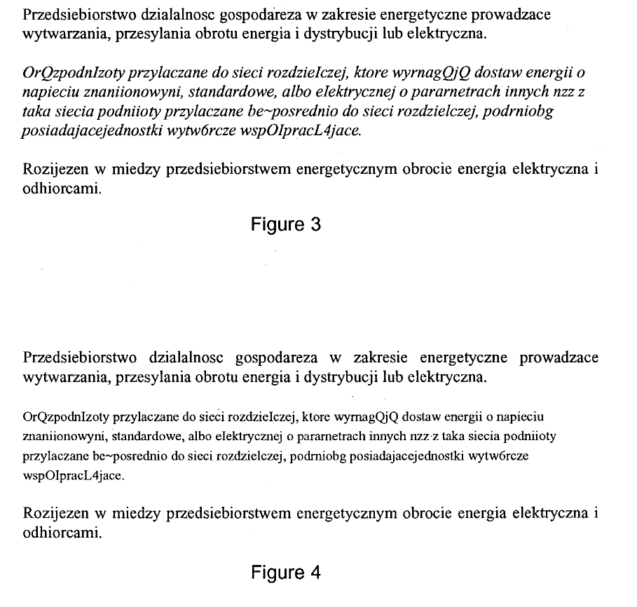

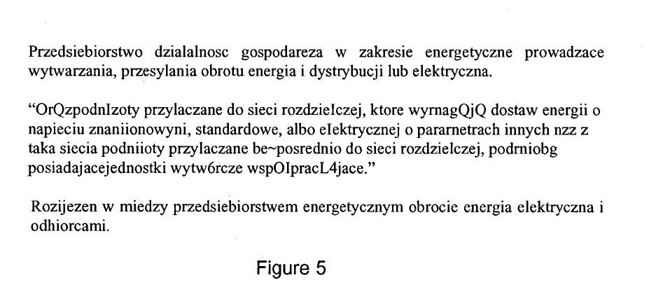

FIG. 3 preserves the italicization of FIG. 1, but removes the indentation, whereas FIG. 4 preserves the font size change of FIG. 2 while eliminating the indentation. A reader might recognize these examples as blocks quotes, but it's not as obvious as it was in FIGS. 1 and 2. Indentation is a crucial characteristic of block quotes. If typographers do not use this formatting property, they typically surround the quoted block with explicit quote marks as shown in FIG. 5.

Empirical research, based on an examination of thousands of pages of documents, has produced a taxonomy of objects that are in general use in documents, along with visual (typographic) cues that communicate the objects on the page or screen, and an analysis of which combinations of cues are sufficient to identify specific objects. These results provide a repository of typographic knowledge that is employed in the structure identification process.

Typographical taxonomy classifies objects into the typical categories that are commonly expected (block/inline, text/non-text), with certain finer categorizations—to distinguish different kinds of titles and lists, for example. In the process of building a taxonomy, the number of new distinct objects found decreases with time. The ones that are found are generally in use in a minority of documents. Furthermore, most documents tend to use a relatively small subset of these objects. The set of object types in general use in typography can be considered to be manageably finite.

The set of visual cues or characteristics that concretely realize graphical objects is not as easy to capture, because for each object there are many ways that individual authors will format it. As an example, there are numerous ways in which individual authors format an object as common as a title. Even in this case, however, the majority of documents use a fairly well-defined set of typographical conventions.

Although the list of elements in the taxonomy is large, the visual cues associated with each element are sufficiently stable over time to provide the common, reliable protocol that authors use to communicate with their readers, just as programs use XML to communicate with each other.

The present invention creates a Document Structure Model (DSM) through the three phase process of Visual Data Acquisition (VDA), Visual Tokenization and Document Structure Identification. Each of these three phases modifies the DSM by adding further structure that more accurately represents the content of the document. The DSM is initially created during the Visual Data Acquisition phase, and serves as both input and output of the Visual Tokenization and the Document Structure Identification phases. Each of the three phases will be described in greater detail below. The DSM itself is a data construct used to store the determined structure of the document. During each of the three phases new structures are identified, and are introduced into the DSM and associated with the text or other content with which they are associated. One skilled in the art will appreciate that the structures stored in the DSM are similar to objects in programming languages. Each structure has both characteristics and content that can be used to determine the characteristics of other structures. The manner in which the DSM is modified at each stage, and examples of the types of structures that it can describe will be apparent to those skilled in the art in view of the discussion below.

The DSM is best described as a model, stored in memory, of the document being processed and the structures that the structure identification process discovers in it. This model starts as a “tabula rasa” when the structure identification process begins and is built up throughout the time that the structure identification process is processing a document. At the end, the contents of the DSM form a description of everything the structure identification process has learned about the document. Finally, the DSM can be used to export the document and its characteristics to another format, such as an XML file, or a database used for document management.

Each stage of the structure identification process reads information from the DSM that allows it to identify structures of the document (or allows it to refine structures already recognized). The output of each stage is a set of new structures—or new information attached to existing structures—that is added to the DSM. Thus each stage uses information that is already present in the DSM, and can add its own increment to the information contained in the DSM. One skilled in the art will appreciate that the DSM can be created in stages that go through multiple formats. It is simply for elegance and simplicity that the presently preferred embodiment of the present invention employs a single format, self modifying data structure.

At the beginning of a structure identification process, the DSM stands empty. The first stage of the structure identification process consists of reading a very detailed record of the document's “marks on paper” (the characters printed, the lines drawn, the solid areas rendered in some colour, the images rendered) which has preferably been extracted from the PDL file by the VDA phase. A detailed description of the VDA phase is presented below.

After VDA, the document is represented as a series of segments in the DSM. Segments are treated as programming objects, in that a given segment is considered to be an instance of an object of the class segment, and is likely an instance of an object of one of the segment subclasses. Each Segment has a set of characteristics that are used in subsequent stages of the structure identification process. In the Visual Tokenization phase, the characteristics of the segments are preferably used to:

combine or split individual Segments

form higher-level objects called Elements which act as containers of Segments. As the structure identification process continues, the DSM contains more Elements.

identify some Segments (or parts of Segments) as “Marks”, or potential “Marks”, special objects that may signify the start of list-items, such as bullet-marks, or sequence marks like “2.4 (a)”

identify vertical or horizontal “Dividers” formed of either lines or white-space. These separate columns, paragraphs, etc.

Later in the process, Elements themselves are preferably grouped and form the contents of new container-Elements, such as Lists which contain List-items. The processes that group the items together to form these new elements then store the new structure in the DSM for subsequent processes.

Because documents often have several “flows” of text the DSM preferably has provision for yet another type of object the Galley, which will be described in detail below. Galleys are a well known construct in typography used to direct text flow between disjoint regions. Also, for a special area on a page such as a sidebar (text in a box that is to be read separately from the normal text of a story) the DSM can have an object-type called a Domain to facilitate the handling of text based interruptions.

Near the end of the structure identification process, the DSM contains a great many objects including the original Segments which were created during the initial stage of the process; Elements created to indicate groupings of Segments, and also groupings of Elements themselves such as Zones. The Zones themselves are also grouped into Galleys and Domains which form containers of separable or sequential areas that are to be processed separately.

A method of the present invention is now described in detail. The method starts with a visual data acquisition phase. Though in the example described herein reference is specifically made to a Postscript or PDF based input file, one skilled in the art will readily appreciate that these methods can be applied to other PDLs, with PDL specific modifications as needed. A Postscript or PDF file is an executable file that can be run by passing it through an interpreter. This is how Postscript printers generate printed pages, and how PDF viewers generate both printed and onscreen renditions of the page. In a presently preferred embodiment of the invention, the PDL is provided to an interpreter, such as the Ghostscrip™ interpreter, to create a linearized output file. Postscript and PDF PDL files tend not to be ordered in a linear manner, which can make parsing them difficult. The difficulty arises from the fact that the PDL may contain information such as text, images or vector drawings that are hidden by other elements on a page, and additionally does not necessarily present the layout of a page in a predefined order. Though it is recognized that a parser can be designed to interpret a non-linear page layout, with multiple layers, it is preferable that the PDL interpreter provide as output a two dimensional, ordered rendition of the page. In a presently preferred embodiment of the present invention, the output of the interpreter is a parsable linearized file. This file preferably contains information regarding the position of characters on the page in a linear fashion (for example from the top left to the bottom right of a page), the fonts used on the page, and presents only the information visible on a printed page. This simplified file is then used in a second stage of visual data acquisition to create a series of segments to represent the page.

In a presently preferred embodiment the second stage of the visual data acquisition creates a Document Structure Model. The method identifies a number of segments in the document. The segments have a number of characteristics and are used to represent the content of the pages that have undergone the first VDA stage. Preferably each page is described in terms of a number of segments. In a presently preferred embodiment there are three types of segments; Text Segments (TSegs), Image Segments (ISegs) and Rule Segments (RSegs). TSegs are stretches of text that are linked by a common baseline and are not separated by a large horizontal spacing. The amount of horizontal spacing that is acceptable is determined in accordance with the font and character set metrics typically provided by the PDL and stored in the DSM. The creation of TSegs can be performed by examining the horizontal spacing of characters to determine when there is a break between characters that share a common baseline. In a presently preferred embodiment, breaks such as the spacing between words are not considered sufficient to end a TSeg. RSegs are relatively easy to identify in the second stage of the VDA as they consist of defined vertical and horizontal rules on a page. They typically constitute PDL drawing commands for lines, both straight and curved, or sets of drawing commands for enclosed spaces, such as solid blocks. RSegs are valuable in identification of different regions or Zones in a page, and are used for this purpose in a later stage. ISegs are typically either vector or bitmap images. When the segments are created and stored in the DSM a variety of other information is typically associated with them, such as location on the page, the text included in the TSegs, the characteristics of the image associated with the ISegs, and a description of the RSeg such as its length, absolute position, or its bounding box if it represents a filled area. A set of characteristics is maintained for each defined segment. These characteristics include an identification number, the coordinates of the segment, the colour of the segment, the content of the segment where appropriate, the baseline of the segment and any font information related to the segment.

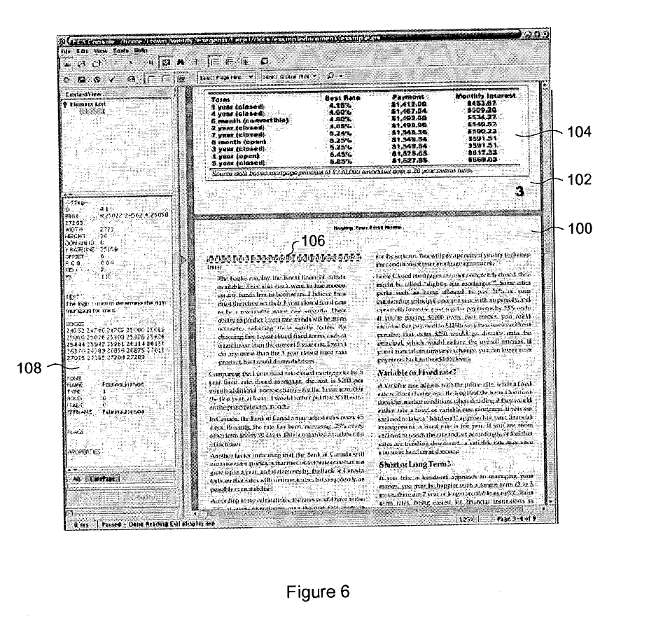

FIG. 6 illustrates a document after the second stage of the visual data acquisition. The lines of text in the lower page 100 are underlined indicating that each line is identified as a text segment. In the upper page 102 the text segments represent what a reader would recognize as the cells in a table 104. As described above the text segments are created by finding text that shares a common baseline and is not horizontally separated from another character by abnormally large spacing. The top line of text in the first column is highlighted, and the window 108 in the lower left of the screen capture indicates the characteristics of selected TSeg 106. The selected object is described as a TSeg 106, and assigned an element identification number, that exists at defined co-ordinates, having a defined height and width. The location of the text baseline is also defined, as is the text of the TSeg 106. The font information extracted from the PDL is also provided. As described earlier the presence of the font and character information, in the PDL, assists in determining how much of a horizontal gap is considered acceptable in a TSeg 106.

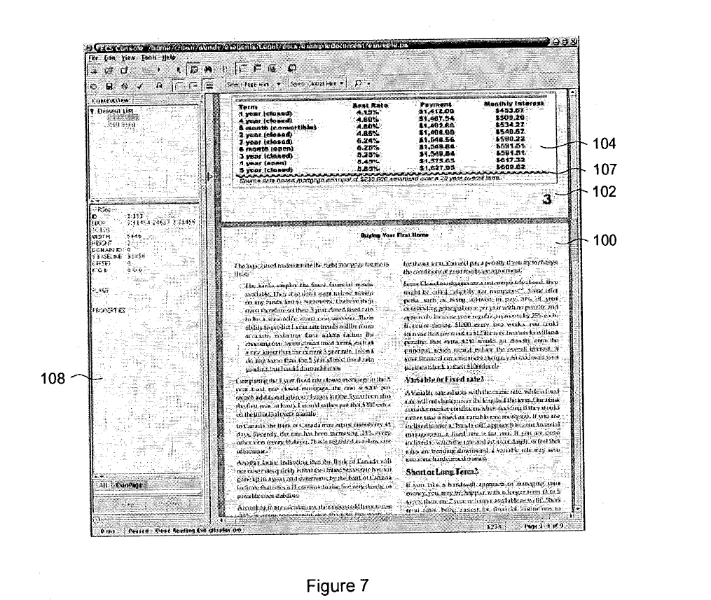

FIG. 7 illustrates the same screen capture, but instead of the TSeg 106 selected in FIG. 6, an RSeg 107 is selected in the table 104 on the top page 102. The RSeg has an assigned identification number, and as indicated by the other illustrated properties in window 106, has a bounding box, height, width and baseline.

In the second stage of the process of the presently preferred embodiment of the present invention, the document undergoes a visual tokenization process. The tokenization is a page based graphical analysis using pattern recognition techniques to define additional structure in the DSM. The output of the VDA is the DSM, which serves as a source for the tokenization, which defines further structures in the document and adds them to the DSM. The visual tokenization process uses graphical cues on the page to identify further structures. While the VDA stage provides identification of RSegs, which are considered Dividers that are used to separate text regions on the page, the Visual Tokenization identifies another Divider type, a white space Divider. As will be illustrated below, white space blocks are used to delimit columns, and typically separate paragraphs. These whitespace Dividers can be identified using conventional pattern recognition techniques, and preferably are identified with consideration to character size and position so that false Dividers are not identified in the middle of a block of text. Both whitespace and RSeg Dividers can be assigned properties such as an identification number, a location, a colour in addition to other property information that may be used by later processes. The intersection of different types of Dividers, both whitespace and RSeg type Dividers, can be used to separate the page into a series of Zones. A Divider represents a rectangular section of a page where no real content has been detected. For example, if it extends horizontally, it could represent space between a page header and page body, or between paragraphs, or between rows of a table. A Divider object will often represent empty space on the page, in which case it will have no content. But it could also contain any segments or elements that have been determined to represent a separator as opposed to real content. Most often these are one or more RSegs (rules), but any type of segment or element is possible.

A page with columns is preferably separated into a series of Zones, each representing one column. A Zone represents an arbitrary rectangular section of a page, whose contents may be of interest. Persistent Zone objects are created for the text area on each page, the main body text area on each page, and each column of a multi-column page. Zones are also created as needed whenever reference to a rectangular section is required. These Zones can be discarded when they are no longer necessary. Such temporary Zones still have identification numbers. Zone objects can have children, which must be other Zones. This allows a column Zone to be a child of a page Zone. Whereas the bounding box of an element is determined by those of its children, the bounding box of each Zone is independent. In each Zone, whitespace Dividers can be used as an indication of where a candidate paragraph exists. This use of Zones and Dividers assists in the identification of a new document structure, that is introduced in the stage: a block element (BElem). BElems serve to group a series of TSegs to form a paragraph candidate. All TSegs in a contiguous area (usually delineted by Dividers), with the same or very similar baelines are examined to determine the order of their occurance within the BElem being created. The TSegs are then grouped in this order to form a BElem. The BElem is a container for TSegs and is assigned and ID number, coordinates and other characteristics, such as the amount of space above and below, a set of flags, and a listing of the children. The children of a BElem are the TSegs that are grouped together, which can still retain their previously assigned properties. The set of flags in the BElem properties can be used to indicate a best guess as to the nature of a BElem. As earlier indicated a BElem is a paragraph candidate, but due to pagination and column breaks it may be a paragraph fragment such as the start of a paragraph that is continued elsewhere, the end of a paragraph that is started elsewhere, or the middle of a paragraph that is both started and ended in other areas, and alternately it may be a complete paragraph. The manner in which a BElem starts and ends are typically considered indicative of whether the BElem represent a paragraph or a paragraph fragment.

The Visual Tokenization phase serves as an opportunity to identify any other structures that are more readily identifiable by their two dimensional layout than their content derived structures. Two such examples are tables and the marks for enumerated and bulleted lists.

In the discussion of the identification of tables it is necessary to differentiate between a table grid and a full table. A table grid is comprised of a series of cells that are delineated by Dividers: either whitespace or RSegs. A full table comprises the table grid and optionally also contains a table title, caption, notes and attribution where any of these are present or appropriate.

Table grid recognition in the Visual Tokenization phase is done based on analysis of Dividers. Further refinements are preferably performed in later processes. Recognition of table grids starts with a seed which is the intersection of two Dividers. The seed grows to become an initial bounding box for the table grid. The initial table grid area is then reanalyzed more aggressively for internal horizontal and vertical Dividers to form the rows and columns of cells. The initial bounding box then grows both up and down to take in additional rows that may have been missed in the initial estimate. The resulting table grid is then vetted and possibly rejected. The grid structure of the table is stored as a TGroup object, which contains the RSegs that form the grid, and will eventually also contain the TSegs that correspond to the cell contents.

The seed for recognition is the intersection of a vertical and horizontal Divider. The vertical Divider is preferably rightmost in the column. The seed might have text on the right of this vertical Divider which is not included in initial bounding box of the grid. But after the initial bounding box grows, the grid will include or exclude the text based on the boundaries of the vertical and horizontal Divider and the text.

From this seed, four Dividers are found that form a bounding box for a table grid. Potential TGroups are rejected if such a box can not be formed. Note that whitespace Dividers can be reduced in their extent to help form this boundary, but content Dividers are of definite extent. So if both the top and bottom Dividers are RSegs, they need to have the same left and right coordinates, within an acceptable margin. The same applies for left and right RSegs type Dividers.

In one embodiment of the present invention, three types of table grids are identified: fully boxed, partially boxed and unboxed. In a fully boxed table, rows and columns are all indicated with content Dividers (proper ink lines). In an unboxed table, only whitespace is used to separate the columns—and there may not even be extra whitespace to separate the rows. Partially boxed TGroups are intermediate in that they are often set off with content Dividers at the top and bottom, and possibly content Divider to separate the header row from the rest of the grid, but otherwise they lack content Dividers.

For unboxed tables, table grid boundaries that contain images or sidebars are rejected. Other tables allow for images inside, but due to the nature of unboxed tables, images and sidebars are typically considered to be outside the TGroup. Also, if the contents of the sidebar inside the probable table grid is like that of the table grid, the sidebar is undone and the insides of the sidebar are included in the grid. Table grid boundaries are rejcted if they lack internal vertical Dividers for a boxed table. The table grid boundary coordinates can be adjusted within a tolerance if required to include vertical content Dividers that extend slightly beyond the current boundaries.

From this initial boundary, an attempt is made to grow both up and down. This is done in steps. Each step involves looking at all the objects up to (or down to) the next horizontal “content” Divider, and seeing if they can be joined into the current table grid. Horizontal white space Dividers between text and sidebars are treated as content Dividers for this purpose.

Within the boundaries of the table grid, horizontal and vertical Dividers are recreated in a more aggressive way. The Visual Tokenization process assumes that inside a table grid, it is reasonable to form vertical Dividers on less evidence than would be acceptable outside a TGroup. Normally short Dividers are avoided on the premise that they are likely nothing more than coincidence (rivers of whitespace between words formed by chance). In a candidate table area, it is far more likely that these are Dividers. Likewise, TSegs are broken at apparent word boundaries when these boundaries correspond to a sharp line formed by the edges of several other TSegs.

For table grids without obvious grid lines, horizontal Dividers are formed at each new line of text. Outside the context of a table grid, this would obviously be excessive. Potential table grids, once formed, are then vetted and possibly rejected. They are rejected if only one column has been formed as it is likely that this is some text structure for which table markup is not required. They are rejected if two columns have been formed and the first column consists of only marks. In this case, it is more likely that this is a list with hanging marks. For or boxed tables these two question for rejecting a grid do not apply.

In one embodiment, users are able to provide hints, or indicate, grid boundaries which the tokenization engine then does not question. Hinted tables are not subject to the reject table rules previously discussed as it is assumed that a user indicated table is intended to be a table even if it does not meet the predefined conditions.

At the end of TGroup recognition, Zones are created. A TGroup Zone is created for the whole grid and Leaf Zones are created in the TGroup Zone for cells of the TGroup element, which is the container created to hold the TSegs that represent the cells of the table. A later pass, in the document structure identification stage (DSI), preferably takes the measure of the column widths, text alignments, cell boundary rules, etc, and creates the proper structures. This means creation of Cell, Row and TGroup BElems and calculation of properties like column start, column end, row start, row end, number of rows, and number of columns can be performed at a later stage.

Enumerated lists tend to follow one of a number of enumeration methods, such methods including increasing or decreasing numbers, alphabetic values, and Roman numerals. Bulleted lists tend to use one of a commonly-used set of bullet-like characters, and use nesting methods that involve changing the mark at different nesting levels. These enumeration and bullet marks are flagged as potential list marks. Further processing by a later process to confirm that they are list marks and are not simply an artefact of a paragraph split between Zones.

During the Tokenization process, higher order elements, such as BElems, TGroups and Zones are introduced. Just as with the simpler elements like TSegs, RSegs, and ISegs each of these new elements is associated with a bounding box that describes the location of the object by providing the location of its edges.

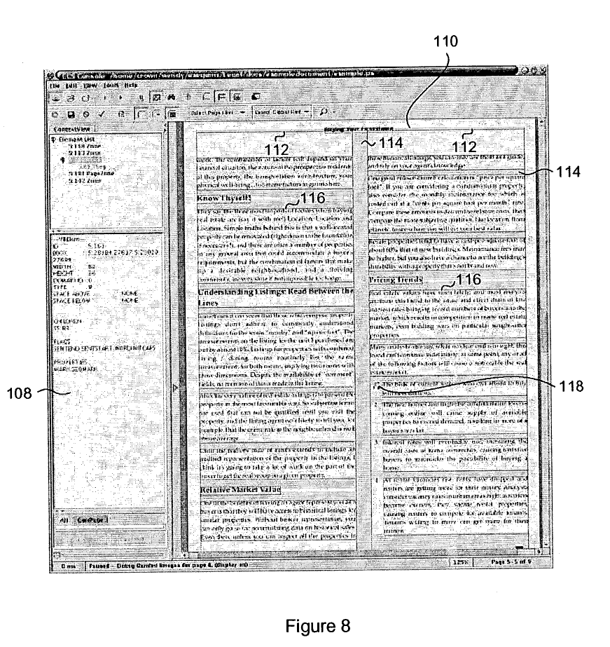

FIG. 8 illustrates the result of the Visual Tokenization phase. Zones 110/112 have been identified (on this page, both a page Zone 110 and column Zones 112), Dividers 114 have been identified, and indicated in shading, BElems 116 have been formed around the paragraph candidates, and list marks 118 have been identified in front of the enumerated list. A list mark 118 has been selected and its properties are shown in the left hand window 108. The list mark 118 has an ID, a set of coordinates, a height, a width, and indication that there is no height above or below, that is has children, and a set of flags, and additionally is identified as a potential sequence mark.

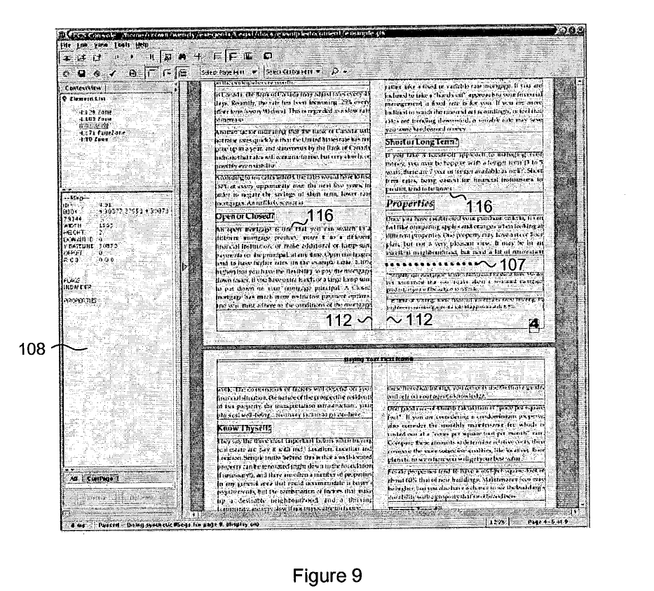

FIG. 9 illustrates a different section of the document after the Visual Tokenization phase. Once again BElems 116 and column Zones 112 have been identified, and an RSeg 107 has been selected. This RSeg 107 divides a column from footnote text, and in addition to the previously described properties of RSegs, a flag has been set indicating that it is a Divider in window 108.

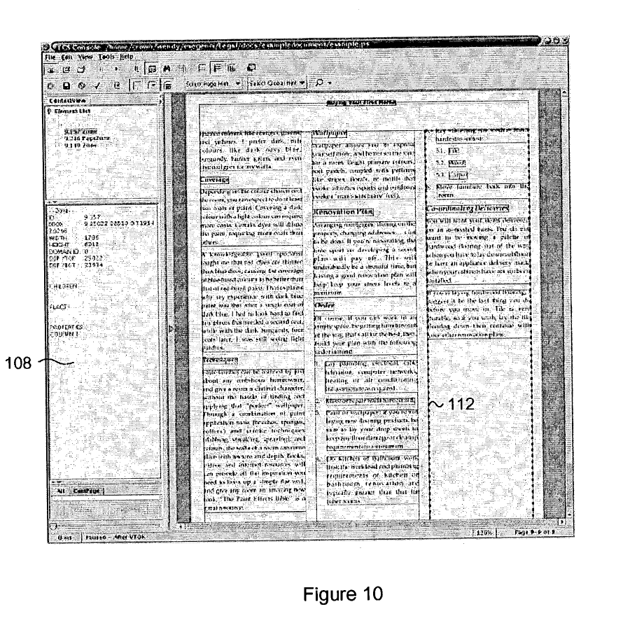

FIG. 10 illustrates yet another section of the document, where a column Zone 112 has been identified and selected. The properties of the selected column Zone are illustrated in the left hand side window 108. The column Zone 112 is assigned an id number, a set of location coordinates, a width and height, and the properties indicate that it is the first column on the page.

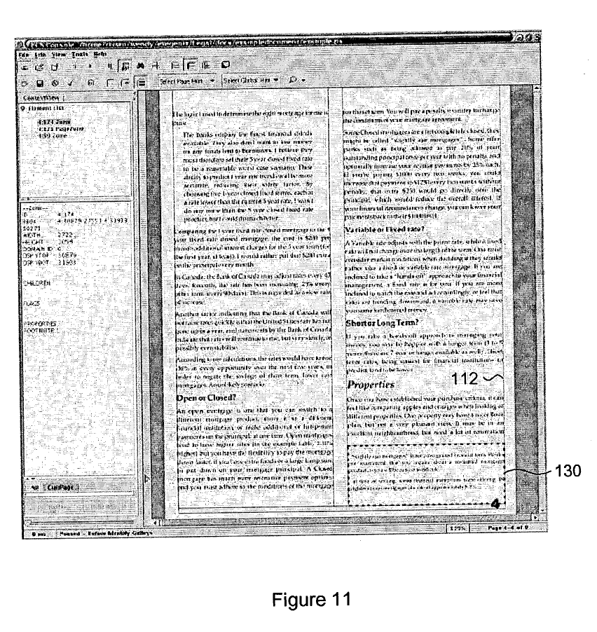

FIG. 11 illustrates the same page as illustrated in FIG. 9, but shows the selection of a footnote Zone 130 inside a column Zone 112. The footnote Zone 130 is identified due to the presence of the RSeg 107 selected in FIG. 9. The footnote Zone 130 has its own properties, much as the column Zone 112 illustrated in FIG. 10.

The final phase of the structure identification is referred to as Document Structure Identification (DSI). In DSI document wide traits are used to refine the structures introduced by the tokenization process. These refinements are determined using a set of rules that examine the characteristics of the tokenized object and their surrounding objects. These rules can be derived based on the characteristics of the elements in the typographic taxonomy. Many of the cues that allow a reader to identify a structure, such as at title or a list, can be implemented in the DSI process through rules based processing.

DSI employs the characteristics of BElems such as the size of text, its location on a page, its location in a Zone, its margins in relation to the other elements on the page or in its Zone, to perform both positive and negative identification of structure. Each element of the taxonomy can be identified by a series of unique characteristics, and so a set of rules can be employed to convert a standard BElem into a more specific structure. The following discussion will present only a limited sampling of the rules used to identify elements of the taxonomy, though one skilled in the art will readily appreciate that other rules may be of interest to identify different elements.

In the lower page segment illustrated in FIG. 6, a block quote is present, and is visually identified by a reader due to the use of additional margin space in the Zone. During the DSI phase, this block quote is read as a BElem created during the tokenization phase. Above and below it are other BElems representing paragraphs or paragraph segments. The BElem that represents the block quote is part of the same column Zone as the paragraphs above and below it, so a comparison of the margins on either side of the block quote BElem, to the margins of the BElems above and below it indicates that increased margins are present. The increased margins can be determined through examining the coordinate locations of the BElems and noting that the left and right edges of the bounding box are at different locations than those of the neighbouring BElems. Because it is only one BElem that has a reduced column width, and not a series of BElems that have reduced column width, it is highly probable that the BElem is a block quote and not a list, thus either the characteristics of the BElem can be set to indicate the presence of a block quote. In other examples, an entire BElem will be differentiated from the above and below BElems using characteristics other than margin differences. In these cases tests can be performed to detect a font size change, a typeface change, the addition of italics, or other such characteristics available in the DSM, to determine that a block quote exists.

The DSI phase is also used to identify a number of elements that cannot be identified in the tokenization phase. One such element is referred to as a synthetic rule. Whereas a rule is a line with a defined start and end point, a synthetic rule is intended by the author to be a line, but is instead represented by a series of hyphens, or other such indicators (“|” are commonly used for synthetic vertical rules). During the tokenization phase the synthetic rule appears as a series of characters and so it is left in a BElem, but during DSI it is possible to use rules based processing to identify synthetic rules, and replace them with RSegs. After doing this it is often beneficial to have the DSI examine the BElems in the region of the synthetic rules to determine if the synthetic rules were used to define a table, that has been skipped by the tokenization process to determine if the syntheic rules were used to define a table that has been skipped by the tokenization process, or to delimit a footnote Zone.

Though the tokenization phase identifies both TGroup and list mark candidates, it is during DSI that the overall table, or complete list is built, and TGroups defined by synthetic rules are identified. In the case of an identified TGroup, the characteristics of the table title, caption, notes and possible attribution can be used to test the BElems in the vicinity of the identified TGroup to complete the full table identification. The identification of a Table title is similar to the identification of titles, or headings, in the overall document and will be described in detail in the discussion of the overall identification of titles. After the tokenization phase has identified a TGroup, the DSI phase of the process can refine the table by joining adjacent TGroups where appropriate, or breaking defined TSegs into different TGroup cells when a soft cell break is detected. Soft cell breaks are characters, such as ‘%’ that are considered both content and a separator. The tokenization stage should not remove these characters as they are part of the document content, so the DSI phase is used to identify that a single TGroup cell has to be split, and the character retained. These soft cell break identifiers are handled in a similar manner to synthetic rules, but typically no RSeg is introduced as soft cell breaks tend to be found in open format tables.

The DSI process preferably takes the measure of the column widths, text alignments, cell boundary rules, etc, and creates the proper table structures. This means creation of Cell, Row and TGroup elements and calculation of characteristics like column start, column end, row start, row end, number of rows, number of columns etc. Additional table grid recognition may be done later, in DSI, based on side-by-side block arrangements as will be apparent to one skilled in the art.

List identification relies upon the identification of potential list marks during the tokenization phase. Recognition of the marks is preferably done in the tokenization phase because it is common that marks are the only indication of new BElems. However, it will be understood by those skilled in the art that this could be done during DSI at the expense of a more complex DSI process. One key aspect of list identification is the re-consideration of false postive list marks, the potential list marks identified by the tokenization that through the context of the document are clearly not part of a list. These marks are typically identified in conjunction with a number of bullet starting a new line. This results in the number or bullet appearing at the start of a BElem line. This serves as a flag to the tokenization process that a list mark should be identified. These false marks cannot be corrected in isolation, but are obvious errors with the context that the larger document view provides. Thus a series of rules based on finding the previous enumerated mark, or a subsequent enumerated mark, following the list entry can be used to detect the false positives when the test fails. Upon detection of the test failure, the potential list mark is preferably joined to the TSeg on the same line, and the BElem that it should belong to.

As an overview of a sample process to correct false marks the following method is provided. Traverse the document to find a list mark candidate identified by the tokenization. If it is a continuing list, determine the preceding and following list marks (based on use of alphabetic, numeric, roman numerals, or combination), and scan to detect the preceding or following mark nearby. If no such mark is found correct, otherwise continue.

If a list is identified as having markers “1”, “2”, “3”, and then a second list is detected having markers “a”, “b” and “c”, the “3” mark should be kept in memory, so that a subsequent “4” marker will not be accidentally ignored. If a “4” marker is detected after the end of the “a” “b” “c” sequence, the “a” “b” “c” sequence is categorized as a nested list.

The final example of the rules engine in DSI being used to determine structure will now be presented with relation to the identification of titles, also referred to as headings. This routine uses a simple rules engine. For a given BElem, a rule list associated with the characteristics of a title is selected. The rules in the list are run until a true statement is found. If a true statement is found the associated result (positive or negative identification of a title) is returned. If no true statement is found the characteristics of the BElem are not altered. If either a positive or negative identification is made, the BElem is appropriately modified in the DSM to reflect a change in its characteristics.

In a presently preferred embodiment, a series of passes through each Galley is performed. In the first pass the attributes examined are whether the BElem is indented or centered, the font type and size of the BElem, the space above and below the BElem, whether the content of the BElem is either all capitalized or at least the first character of each major work is capitalized. All these characteristics are defined for the BElem in the DSM. Typically the first pass is used to identify title candidates. These title candidates are then processed by another set of rules to determine if they should be marked as a Title. The rules used to identify titles are preferably ordered, through one skilled in the art will appreciate that the order of some rules can be changed without affecting the accuracy. The following listing of rules should not be considered either exhaustive or mandatory and is provided solely for exemplary purposes.

A first test is performed to determine if the text in the BElem is valid text, where valid text is defined as a set of characters, preferably numbers and letters. This prevents equations from being identified as titles though they share many characteristics in common. In implementation it may be easier to apply this as a negative test, to immediately disqualify any BElem that passes the test “not ValidText”. For BElems not eliminated by the first test, subsequent test are performed. If a BElem is determined to have neighbouring BElems to the right or left, it is likely not a title. This test is introduced to prevent cells in a TGroup from being identified as titles. If it is determined that the BElem has more than 3 lines it is preferably eliminated as a potential title, as titles are rarely 4 or more lines long. If the BElem is the last element in a Galley it is disqualified as a title, as titles do not occur as the last element in a Galley. If the BElem has a Divider above it, or is at the top of a page, and is centered, it is designated as a title. If the BElem has a Divider above it, or is at the top of a page, is a prominent BElem, as defined by its typeface and font size for example, and does not overhang the right margin of the page, it is designated as a title. Other such rules can be applied based on the properties of common titles to both include valid titles and exclude invalid titles.

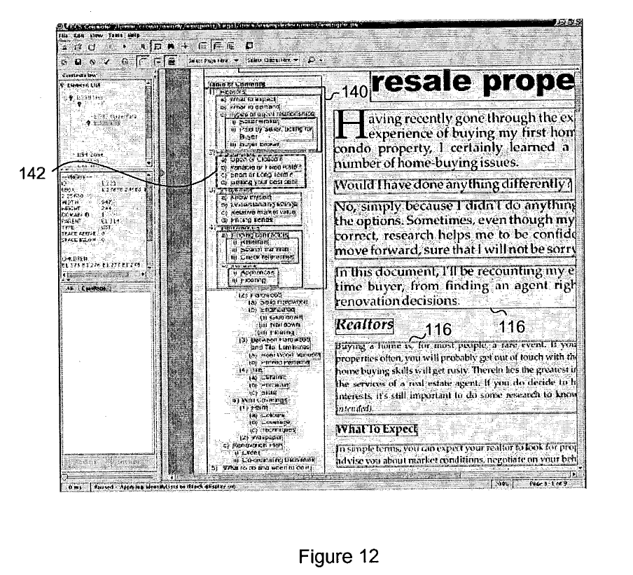

FIG. 12 illustrates a portion of a document page after the DSI phase of the structure identification. BElems 116 are identified in boxes as before, and an inset block (Iblock) is identified. Inside the Iblock 140 is an enumerated list, with nested inner lists 142, one of which is selected. The properties of the inner list indicate an identification number, a coordinate location, a height and width, a domain and the space above and below the inner list. Additionally, the inner list specifies the existence of children, which are the enumerated TSegs of the list, and a parent id, which corresponds to the parent list in the Iblock 140.

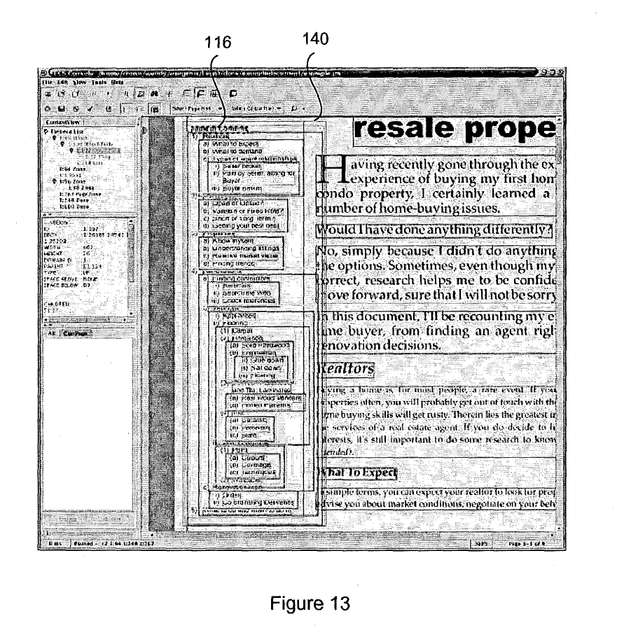

FIG. 13 illustrates the same page portion as illustrated in FIG. 12. A BElem 116 inside the Iblock 140 is selected. The selected BElem 116 has and id, a coordinate location, a height and width, a domain (specifying the domain corresponding to the Iblock 140), a parent which specifies the Iblock id, the amount of space below the BElem 116, and a list of the children TSegs.

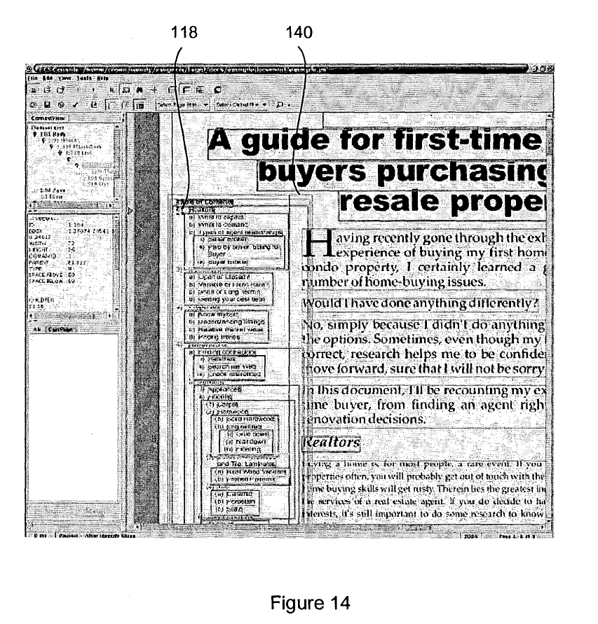

FIG. 14 illustrates the same page illustrated in FIGS. 12 and 13. A list mark 118 is selected in the Iblock 140. The list mark 118 has the assigned properties of an id, a set of location coordinates, a height and width, a domain, a parent specifying the list to which it belongs inside of the Iblock 140, a type indicating that it is a list mark, and a list of the children TSegs.

Though described earlier in the context of the Tokenization phase, a description of BElems is now presented, to provide information about how the BElem is identified during both the Visual Tokenization and DSI phases. BElem recognition occurs at two main points within the overall process: initial BElem recognition is done in the visual tokenization phase; and then BElems are corrected in the document structure identification phase (DSI). Additionally, BElems that have been identified as potential list marks and then rejected as list marks during DSI will be rejoined to their associated BElems within the DSI process during list identification.

During Tokenization, initial BElem recognition is performed. In the initial pass, the identification process is restricted to leaf Zones. A leaf Zone may be a single column on a page, a single table cell or the contents of an inset block such as a sidebar. Block recognition is performed after the baselines of TSegs have been corrected. Baseline correction adjusts for small variations in the vertical placement of text, effectively forming lines of text. The baseline variations compensated for may be the result of invisible “noise”, typically the result of a poor PDL creation, or visible superscripts and subscripts. In either case, each TSeg is assigned a dominant baseline, thus grouping it with the other text on that line in that leaf Zone. This harmonization of baselines allows BElem recognition to work line by line, using only local patterns to decide whether to include each line in the currently-open block or to close the currently open block and start a new one.

When applied to a leaf Zone, block recognition proceeds through the following steps:

1. Collect all text, rule and image segments.

2. Form a list of baselines (group the segments into lines).

3. Note where segments abut the segment to the right or left.

4. Identify potential marks at the beginnings of lines.

5. Pass through each line, forming blocks.

For each line, step 5 is preferably based on the following rules. RSegs (rule segments) may represent inlines or blocks. If the RSeg is coincident with the baseline of text on the same line, then it is marked as a form field. If the RSeg is below text, it is tranformed into an underline property on that text. If it is overlapping text, it is transformed to a blackout characteristic. In all these cases, the RSeg is inline. An RSeg on a baseline of its own is considered to start a new block. ISegs (image segments) may or may not indicate a new block. If the image is well to the left or right of any text, then it is considered to be a “floating” decoration that does not interrupt the block structure. If the image is horizontally overlapping text, then the image breaks the text into multiple blocks.

A survey of typeset documents will illustrate to one skilled in the art that other rules can be added, and several conditions can be monitored. As an example, if the previous line ends with a hyphen and the current line begins with a lowercase letter it should be seen as a reason to treat the current line as a continuation of the same block as the previous line. Additionally, if there is a RSeg (rule segment) above, this is a reason to start a new block for the current line. If the left indent changes significantly on what would be the third or subsequent line, this is typically an indication that a new BElem is starting. A change in background colour is evidence for a BElem split. A significant change in interline spacing will preferably result in the start of a new BElem. If there is enough room at the end of the previous line (as revealed by the penultimate line) for the first word of the current line, then the current line should be considered to be starting a new BElem. A line that is significantly shorter than the column width (as determined by the last several lines) indicates no-fill text, and the next line should be considered as the start of a new BElem. If the current line has the same right margin as the next line, but is longer than the previous line, then it should be determined that the line is at the start of a new fully-justified BElem. The last test starts a new BElem if the line starts with a probable mark. If BElems are split based on this test, then they are tagged for future reference. If it is later determined that this is a false mark (that it does not form part of any list), the BElem will be rejoined. One skilled in the art will appreciate that the above described test should not be considered either exhaustive or be considered as a set of rules that must be applied in its entirety.

BElem correction is performed during the DSI phase to assist in further refining the BElem structure introduced by the Tokenization phase. The DSI pass is able to use additional information such as global statistics that have been collected across the whole document. Using this additional information, some of the original blocks may be joined together or further split.

BElems are combined in a number of cases including under the following conditions. BElems that have been split horizontally based on wide interword spacing may be rejoined if it is determined that the spacing can be explained by full justification in the context of the now-determined column width, which is based on properties of the column Zone in which the BElem exists. A sequence of blocks in which all lines share the same midpoint will be combined, as this joins together runs of centered lines. The same is done for runs of right-justified lines. Sometimes first lines of BElems may have been falsely split from the remainder of the block; based on the statistics about common first-line indents, this situation can be identified and corrected. BElems may have been split by an overaggressive application of the no-fill rules, in which case the error can be corrected based on additional evidence such as punctuation at the end of BElems. BElems may additionally be combined when they have the identical characteristics.

BElems are also split during the DSI phase, including under the following conditions. If there is a long run of centered text, and there is no punctuation evidence that it is to be a single BElem, then it may split line by line. If there is no common font face (a combination of font and size) between two lines in a BElem, the BElem is split between the two lines. BElems that contain nothing but a series of very short lines are indicative of a list, and are split. Based on statistics gathered from the entire Galley instead of just the Zone, BElems may also be split if there is whitespace sufficiently large to indicate a split between paragraphs.

Another important structure identified by the DSI process is the Galley. Galleys define the flow of a content in a document through columns and pages. In each Galley, both page Zones and column Zones are assigned an order. The ordering of the Zones allows the Galley follow the flow of the content of the document. A separate Galley is preferably defined for the footnote zone, which allows all footnotes in the document stored together. To create the Galleys, the Zones, for pages, columns and footnotes are identified as described above. Each Zone is assigned a type after creation. When all the Zones in a document are identified and assigned a type, the contents of each type of Zone are put into a Galley. Preferably the Galley entry is done sequentially, so that columns are represented in their correct order. In some cases a marker at the bottom of a Zone may serve as an indicator of which Zone is next, much as a newspaper refers readers to different pages with both numeric and alphabetic markers when a story spans multiple pages. During the DSI process it is preferably that the identification of Galleys precedes the identification of titles, as a convenient test to determine if a BElem is a title is based on the position of the Belem in the Galley.

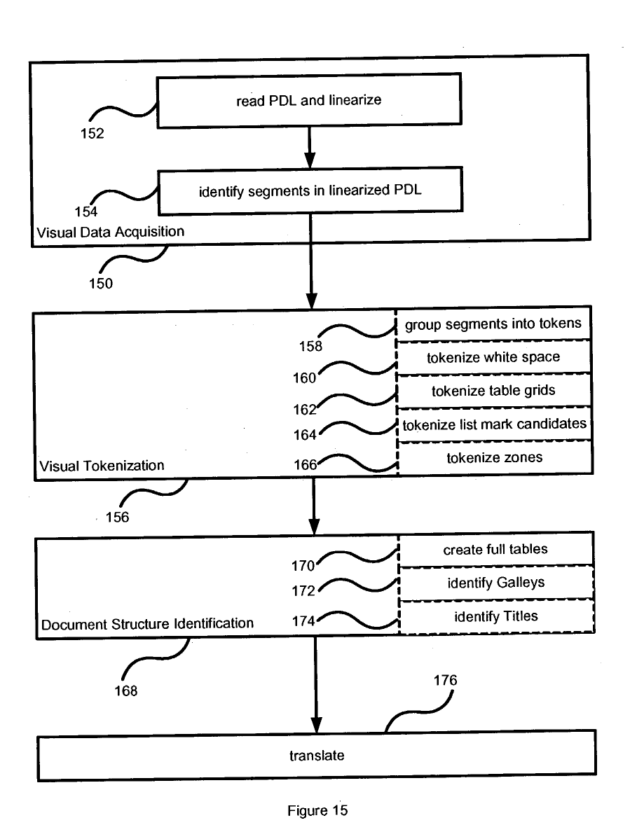

One skilled in the art will readily appreciate that the method described above is summarized in the flowchart of FIG. 15. The method starts with a Visual Data Acquisition process in step 150, where a PDL is read, and preferably linearized in step 152, so that segments can be identified in step 154. In a presently preferred embodiment this information is used to create a DSM, which is then read by the Visual Tokenization process of step 156. During the Visual Tokenization segments are grouped to form tokens in step 158, which allows the creation of BElems from Tsegs. White space is tokenized in step 160 to form Dividers. Additionally in steps 162 and 164,table grids and list marks are identified and tokenized. As a further step in Visual Tokenization, Zones are identified and tokenized in step 166. The tokenization information is used to update the DSM, which is then used by the Document Structure Identification process in step 168. In step 170, DSI supports the creation of full tables from the TGroups tokenized in step 162. Galleys are identified and added to the DSM in step 172, while Titles are identified and added to the DSM in step in step 174. After the generation of the DSM by the DSI of step 168, an optional translation process to XML, or another format, can be executed in step 176. One skilled in the art will readily appreciate that the steps shown in FIG. 15 are merely exemplary and do not cover the full scope of what can be tokenized and identified during either of steps 156 or 168.

One skilled in the art will appreciate that simply assigning a serially ordered identification number to each identified element will not assist in selecting objects that must be accessed based on their location. Location based searching is beneficial in determining how many objects of a given class, such as a BElem, fall within a given area of a page. To facilitate such queries a presently preferred embodiment of the present invention provides for the use of a Geometric Index, which is preferably implemented as a binary tree. The Geometric Index allows a query to be processed to determine all objects, such as BElems or Dividers, that lie within a defined region. One skilled in the art will appreciate that one implementation of a geometric index can be provided by assigning identification numbers to the elements based on coordinates associated with the element. For example a first corner of a bounding box could be used as part of an identification number, so that a geometric index search can be performed to determine all Dividers in a defined region by selecting all the dividers whose identification numbers include reference to a location inside the defined region. One skilled in the art will appreciate that a number of other implementations are possible.

While the above discussion has been largely “XML generation”-centric, structure recognition is not just about generating XML files. Other applications for this technology include natural language parsing, which benefits from the ability to recognize the hierarchical structure of documents; and search engine design, which can use structure identification to identify the most relevant parts of documents and thereby provide better indexing capabilities. It will be apparent to one of skill in the art that the naming convention used to denote the object classes above are illustrative in nature and are in no way intended to be restrictive of the scope of the present invention.

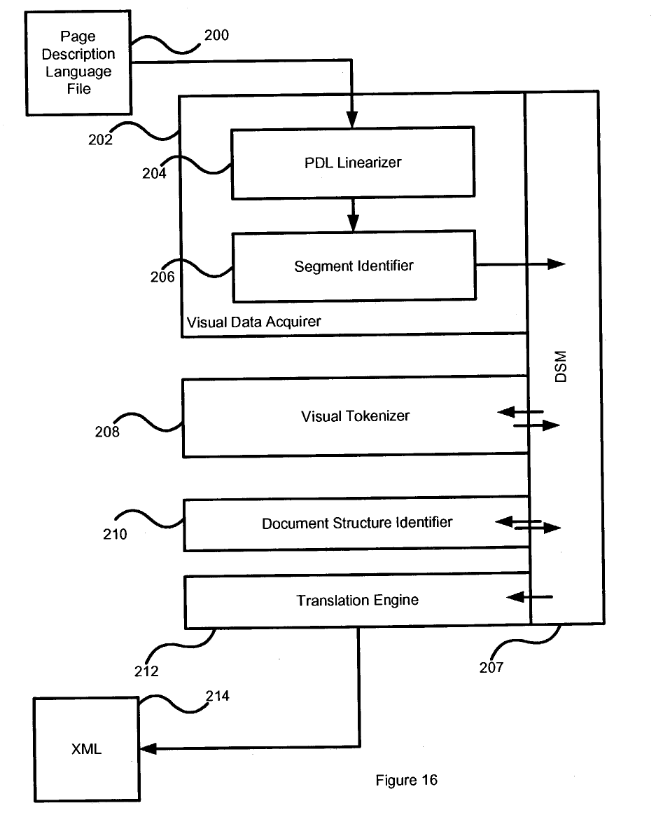

One skilled in the art will appreciate that though the aforementioned discussion has centered on a method of creating a document structure model, the present invention also includes a system to create this model. As illustrated in FIG. 16, a PDL file 200 is read by visual data acquirer 202, which preferably includes both a PDL linearizer 204 to linearize the PDL and create a two dimensional page description, and a segment identifier 206, which reads the linearized PDL and identifies the contents of the document as a set of segments. The output of the visual data acquirer 202 is preferably DSM 207, but as indicated earlier a different format could be supported for each of the different modules. The DSM 207 is provided to visual tokenizer 208, which parses the DSM and identifies tokens representing higher order structures in the document. The tokens are typically groupings of segments, but are also white space Dividers, and other constructs that do not directly rely upon the identified segments. The visual tokenizer 208 writes its modifications back to DSM 207, which is then processed by document structure identifier (DSI) 210. DSI 210 uses rules based processing to further identify structures, and assign characteristics to the tokens introduced in DSM 207 by tokenizer 208. DSM 207 is updated to reflect the structures identified by DSI 210. If translation to a format such as XML is needed, translation engine 212 employs standard translation techniques to convert between the ordered DSM and an XML file 214.

The elements of this embodiment of the present invention can be implemented as parts of a software application running on a standard computer platform, all having access to a common memory, either in Random Access Memory or a read/write storage mechanism such as a hard drive to facilitate transfer of the DSM 207 between the components. These components can be run either sequentially or, to a certain degree they can be run in parallel. In a presently preferred embodiment the parallel execution of the components is limited to ensure that DSI 210 has access to the entire tokenized data structure at one time. This allows the creation of an application that performs Visual Tokenization of a page that has undergone visual data acquisition, while VDA 202 is processing the next page. One skilled in the art will readily appreciate that this system can be implemented in a number of ways using standard computer programming languages that have the ability to parse text.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of creating a document structure model of a computer parsable document having contents on at least one page, the method comprising:
identifying the contents of the document as segments having defined characteristics and representing structure in the document;
creating tokens to characterize the content and structure of the document, each token associated with one of the at least one pages based on the position of each segment in relation to other segments on the same page, each token having characteristics defining a structure in the document determined in accordance with the structure of the page associated with the token; and
creating the document structure model in accordance with the characteristics of the tokens across all of the at least one pages of the document.

2. The method of claim 1, wherein the computer parsable document is a page description language file, and wherein the step of identifying the contents of the document includes the step of converting the page description language to a linearized, two dimensional format.

3. The method of claim 1, wherein a segment type for each segment is selected from a list including text segments, image segments and rule segments to represent character based text, vector and bitmapped images and rules respectively.

4. The method of claim 3, wherein the text segments represent strings of text having a common baseline.

5. The method of claim 1, wherein the characteristics of the tokens define a structure selected from a list including candidate paragraphs, table groups, list mark candidates, Dividers, and Zones.

6. The method of claim 5, wherein one token contains at least one segment, and the characteristics of the one token are determined in accordance with the characteristics of the contained segment.

7. The method of claim 1, wherein one token contains at least one other token, and the characteristics of the container token are determined in accordance with the characteristics of the contained token.

8. The method of claim 1, wherein each token is assigned an identification number which includes a geometric index for tracking the location of tokens in the document.

9. The method of claim 1 wherein the document structure model is created using rules based processing of the characteristics of the tokens.

10. The method of claim 5 wherein at least two disjoint Zones are represented in the document structure model as a Galley.

11. The method of claim 5 wherein the candidate paragraph is represented in the document structure model as a structure selected from a list including titles, bulleted lists, enumerated lists, inset blocks, paragraphs, block quotes, tables, footers, header, and footnotes.

12. A system for creating a document structure model of a computer parsable document having contents on at least one page, the system comprising:
a visual data acquirer for identifying the contents of the document as segments representing structure in the document and having defined characteristics;
a visual tokenizer, connected to the visual data acquirer for receiving the identified segments and for creating tokens to characterize the content and structure of the document, each token associated with one of the at least one pages based on the position of each segment in relation to other segments on the same page, each token having characteristics defining a structure in the document determined in accordance with the structure of the page associated with the token; and
a document structure identifier for creating the document structure model in accordance with the characteristics of the tokens received from the visual tokenizer.

13. The system of claim 12 further including a translation engine for reading the document structure model created by the document structure identifier and creating file in a format selected from a list including Extensible Markup Language, Hypertext Markup Language and Standard Generalized Markup Language, in accordance with the content and structure of the document structure model.
